(19) United States
(12) Patent Application Publication
(10) Pub. No.: US 2014/0196151 A1
(43) Pub. Date: Jul. 10, 2014

(54) PRESERVING GEOMETRIC PROPERTIES OF DATASETS WHILE PROTECTING PRIVACY

(71) Applicant: MICROSOFT CORPORATION, Redmond, WA (US)

(72) Inventors: Nina Mishra, Pleasanton, CA (US); Krishnaram Kenthapadi, Sunnyvale, CA (US); IIya Mironov, Sunnyvale, CA (US)

(73) Assignee: Microsoft Corporation, Redmond, WA (US)

(21) Appl. No.: 13/737,947

(22) Filed: Jan. 10, 2013

(51) Int. Cl. G06F 17/30

(52) U.S. Cl. CPC G06F 17/30569
USPC 726/26

(57) ABSTRACT

The privacy of a dataset is protected. A private dataset is received that includes multiple rows of multidimensional data. Each row may correspond to a user, and each dimension may be an attribute of the user. A projection matrix is applied to each row to generate a lower dimensional sketch of the row. Noise is added to each of the lower dimensional sketches. The sketches with the added noise may be published together with the projection matrix. The sketches preserve geometric relationships of the original dataset including clustering, distances, and nearest neighbor, and therefore may be useful for data mining purposes while still protecting the privacy of the users.

### BACKGROUND

In recent years, there has been an abundance of rich and fine-grained data about individuals in domains such as healthcare, finance, retail, web search, and social networks. It is desirable for data collectors to enable third parties to perform complex data mining applications over such data. However, privacy is an obstacle that arises when sharing data about individuals with third parties, since the data about each individual may contain private and sensitive information.

One solution to the privacy problem is to add noise to the data. The addition of the noise may prevent a malicious third party from determining the identity of a user whose personal information is part of the data or from establishing with certainty any previously unknown attributes of a given user. However, while such methods are effective in providing privacy protection, they may overly distort the data, reducing the value of the data to third parties for data mining applications.

### SUMMARY

A system for protecting the privacy of a dataset is provided. A private dataset is received that includes multiple rows of multidimensional data. Each row may correspond to a user, and each dimension may be an attribute of the user. A projection matrix is applied to each row to generate a lower dimensional sketch of the row. Noise is added to each of the lower dimensional sketches. The sketches with the added noise and the projection matrix may be published. The sketches preserve geometric relationships in the original dataset including clustering, distances, and nearest neighbor, and therefore may be useful for data mining purposes while still protecting the privacy of the users associated with the dataset.

In an implementation, a dataset is received by a computing device. A transformation is applied to the dataset by the computing device to generate a transformed dataset. Noise is added to the transformed dataset by the computing device. The transformed dataset is provided with the added noise by the computing device.

In an implementation, a dataset is received by a computing device. The dataset includes a plurality of rows and each row has a first number of dimensions. For each row of the dataset, a sketch is generated from the row by the computing device. The number of dimensions of each sketch can be less than the number of dimensions in the row dimension. For each sketch, noise is added to the sketch by the computing device. The generated sketches with the added noise are provided by the computing device.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for protecting the privacy of datasets while preserving geometric properties of the datasets;

FIG. 2 is an illustration of an example privacy protector;

FIG. 3 is an operational flow of an implementation of a method for generating a transformed dataset from a dataset;

FIG. 4 is an operational flow of another implementation of a method for generating a transformed dataset from a dataset;

FIG. 5 is an operational flow of an implementation of a method for determining a distance between two rows of the dataset using the transformed dataset; and

FIG. 6 shows an exemplary computing environment in which example embodiments and aspects may be implemented.

### DETAILED DESCRIPTION

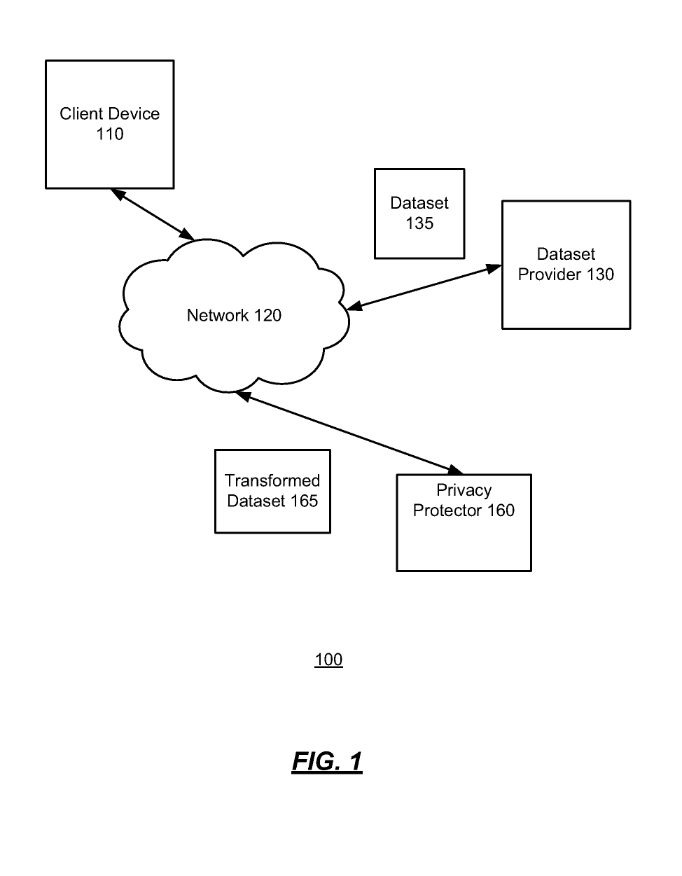

FIG. 1 is an illustration of an exemplary environment 100 for protecting the privacy of datasets while preserving geometric properties of the datasets. The environment 100 may include a dataset provider 130, a privacy protector 160, and a client device 110. The client device 110, dataset provider 130, and the privacy protector 160 may be configured to communicate through a network 120. The network 120 may be a variety of network types including the public switched telephone network (PSTN), a cellular telephone network, and a packet switched network (e.g., the Internet). While only one client device 110, dataset provider 130, and privacy protector 160 are shown, it is for illustrative purposes only; there is no limit to the number of client devices 110, dataset providers 130, and privacy protectors 160 that may be supported by the environment 100.

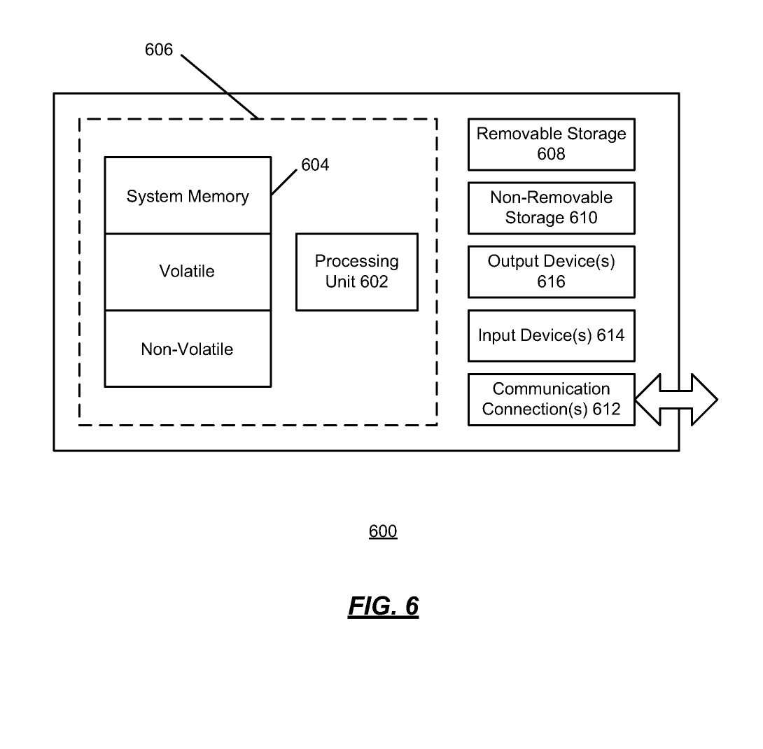

In some implementations, the client device 110 may include a desktop personal computer, workstation, laptop, PDA, smart phone, cell phone, or any WAP-enabled device or any other computing device capable of interfacing directly or indirectly with the network 120, such as the computing device 600 described with respect to FIG. 6. The client device 110 may run an HTTP client, e.g., a browsing program, such as MICROSOFT INTERNET EXPLORER or other browser, or a WAP-enabled browser in the case of a cell phone, PDA or other wireless device, or the like.

The dataset provider 130 may generate a dataset 135. The dataset 135 may comprise a collection of data and may include data related to a variety of topics including but not limited to healthcare, finance, retail, and social networking. The dataset 135 may have a plurality of rows and each row may have a number of values or columns. The number of values associated with each row in the dataset 135 is referred to as the dimension of the dataset 135. Thus, for example, a row with twenty columns has a dimension of twenty.

In some implementations, depending on the type of dataset 135, each row of the dataset 135 may correspond to a user, and each value may correspond to an attribute of the user. For example, where the dataset 135 is healthcare data, there may be a row for each user associated with the dataset 135 and the values of the row may include height, weight, sex, and blood type.

As may be appreciated, publishing or providing the dataset 135 by the dataset provider 130 may raise privacy issues. Even where personal information such as name or social security number have been removed from the dataset 135, malicious users may still be able to identify users based on the dataset 135, or through combination with other information such as information found on the internet or from other datasets. However, third-party researchers may want to use the values of the dataset 135 for research and for data mining purposes.

Accordingly, the privacy protector 160 may receive the dataset 135 and may generate a transformed dataset 165 based on the dataset 135. The transformed dataset 165 may then be published or provided to client devices 110 associated with third-party researchers. The transformed dataset 165 may be generated by the privacy protector 160 to provide one or more privacy guarantees while preserving geometric properties of the original dataset 135.

In some implementations, the privacy protector 160 may guarantee what is referred to as (ε, δ)-differential privacy. An algorithm A satisfies (ε, δ)-differential privacy, if for all inputs X and X′ differing in at most one user's one attribute value, and for all sets of possible outputs \hat{D}⊂Range (A): Pr[A(X)ε\hat{D}]≦e^{ε}·Pr[A(X′)ε\hat{D}]+δ, where the probability is computed over the random coin tosses of the algorithm.

The (ε, δ)-differential privacy guarantee provides that a malicious user or third-party researcher who knows all of the attribute values of the dataset 135 but one attribute for one user, cannot infer with confidence the value of the attribute from the information published by the algorithm (i.e., the transformed dataset 165).

In some implementations, the privacy protector 160 may guarantee a stricter form of privacy protection called ε-differential privacy. In ε-differential privacy, the δ parameter is set to zero. Other privacy guarantees may also be supported, such as privacy guarantees related to comparing posterior probabilities with prior probability, or guarantees related to anonymity.

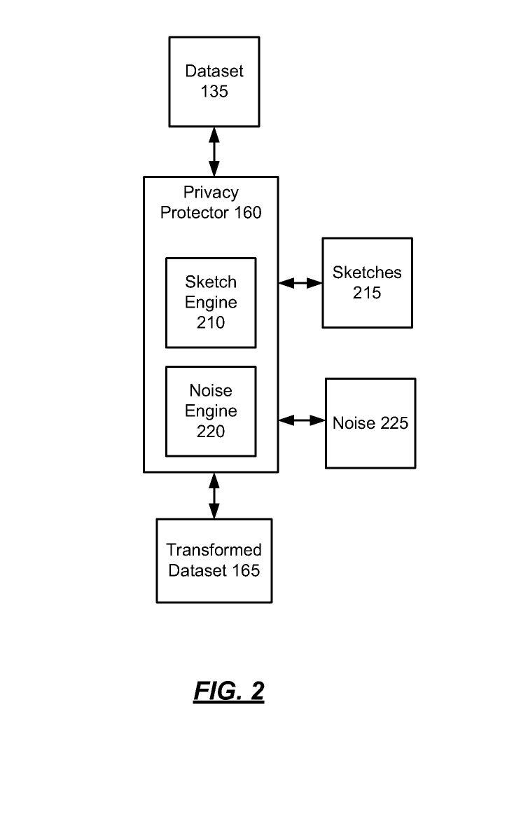

As described further with respect to FIG. 2, the privacy protector 160 may provide the above privacy guarantees by applying a transformation to each row of the dataset 135. The transformation applied to a row may result in a sketch that has fewer dimensions than the row. In addition, the privacy protector 160 may add noise to each of the generated sketches. The resulting sketches with added noise may then be published as the transformed dataset 165 by the privacy protector 160. One or more third-party researchers may then use the transformed dataset 165 for research or experimental purposes because the geometric properties of the dataset 135 are preserved in the transformed dataset 165 (i.e., distance, scalar products, clustering properties, etc.).

FIG. 2 is an illustration of an example privacy protector 160. As shown, the privacy protector 160 includes one or more components including a sketch engine 210 and a noise engine 220. More or fewer components may be supported. The privacy protector 160 may be implemented using a general purpose computing device including the computing device 600.

The sketch engine 160 may generate sketches 215 from each row of the dataset 135. A sketch 215 may refer to any transformation of data of a high dimension to a different lower dimension. Each sketch 215 may be generated using any function from R^{d} to R^{k} where d is the number of dimensions in the dataset 135 and k is the number of dimensions in each sketch 215. The number of dimensions k may be selected by a user or administrator, for example. In general, the greater the value of k selected, more noise is needed to be added to each sketch 215 to provide privacy guarantees. However, as the value of k gets smaller, distortions in the geometric properties of the dataset 135 may be introduced. Distortions may also be introduced due to the additive noise. Thus, the number of dimensions k and the amount of additive noise may be selected to minimize distortion while still providing the desired privacy guarantee. The desired privacy guarantee may be received from a user or administrator, for example.

The particular transformation used to generate each sketch 215 may be independent of the values of the dataset 135, and may be set by a user or administrator. Alternatively, the transformation or function may be selected by the privacy protector 160 based on the values of the dataset 135. In addition, the transformation used may be kept secret by the privacy protector 160 or may be published. Keeping the transformation or function secret may provide additional privacy guarantees depending on the type of privacy being protected by the privacy protector 160.

The transformation may be a projection matrix that maps a d dimensional row of the dataset 135 to a k dimensional sketch. The entries of the projection matrix may be determined by the sketch engine 210. In some implementations, the entries of the projection matrix may be determined independently and uniformly at random from the Gaussian distribution. In other implementations, the entries of the projection matrix may be determined independently and uniformly at random from the set {−1/sqrt(k), 1/sqrt(k)}. In other implementations, the entries of the projection matrix may be determined independently and uniformly at random from the set {−sqrt(3/k), 0, sqrt(3/k)} with probabilities 1/6, 2/3, and 1/6, respectively. Other sets or distributions may be used to determine the entries in the projection matrix.

The noise engine 220 may generate and add noise 225 to the sketches 215. The noise 225 may be added to each value or entry of a sketch 215. The noise 225 may be additive or multiplicative. Where the noise 225 is additive, it may be generated by the noise engine 220 by drawing from one or more of the Laplacian, Binomial, Gaussian, or other discrete and continuous variants.

The generated noise 225 may comprise a noise matrix, and may be generated by the noise engine 220 based on the desired privacy guarantees (ε, δ), and the projection matrix used to generate the sketches 215. In particular, the generated noise may depend on the Iₚ-sensitivity of the projection matrix P. The Iₚ-sensitivity of the d×k projection matrix P may be defined as the maximum Iₚ-norm of any row in P. i.e., wₚ(P)=max_{1≦i≦d}(Σⱼ₌₁^{k}|Pᵢⱼ|^{p})^{1/p}. Equivalently, wₚ(P) may be defined as max∥eᵢP∥ₚ, where {eᵢ}ᵢ₌₁^{d} are standard basis unit vectors.

The noise engine 220 may draw the noise values for the noise matrix randomly and uniformly from the normal distribution N with a mean 0 and a variance σ². The variance σ² of the noise values may depend on the Iₚ-sensitivity of the projection matrix P. More formally, if w₂(P) is the Iₚ-sensitivity of the projection matrix P, assuming δ<½, the noise engine 220 may draw the noise values from N(0, σ²) with

$$σ \geq {w}_{2} ( P ) \frac{\sqrt{2 ( ln ( \frac{1}{2 δ} ) + ε}}{ε} .$$

The privacy protector 160 may provide the sketches 215 with the added noise 225 as the transformed dataset 165. The transformed dataset 165 may be provided directly to a client device 110 associated with a third-party researcher, or the privacy protector 160 may publish the transformed dataset 165 at a location where multiple third-party researchers can access the transformed datasets 165.

As described above, the privacy protector 160 may generate sketches 215 from the dataset 135, and add noise 225 to the generated sketches 215 to provide privacy guarantees while preserving geometric properties of the dataset 215. In some implementations, in order to recover the underlying geometric properties of the dataset 135 from the transformed dataset 165, the client device 110 may first account for any distortions in the transformed dataset 165 due to the addition of the noise 215.

In particular, when determining a geometric property such as the distance between two rows of the transformed dataset 165 (i.e., the distance between the two sketches 215 corresponding to the rows of the original dataset 135), the client device 110 may use a modified distance formula that removes the distortion caused by noise 225 from the distance calculation. Thus, the distance between the two rows of the transformed dataset 165 may be the same or close to the distance between the same two rows of the dataset 135.

In some implementations, the following distance formula for finding the distance between two rows A and B of the dataset 135 using the transformed dataset 165 may be used where \hat{x} and ŷ are the sketches 215 of the transformed dataset 165 corresponding to the rows A and B respectively, k is the dimension of the transformed dataset 165, and σ is a noise parameter based on the noise 225 that was added to the transformed dataset 165:

distance (A, B)=∥\hat{x}−ŷ∥₂²−2kσ²

The discount factor 2kσ² in the distance formula may represent the expected distortion in the squared distance due to the addition of Gaussian noise. Other discount factors may be used depending on the type of noise 225 that is added by the noise engine 220. By repeatedly using the distance function including the discount factor shown above, the third-party researchers may be able to use the client device 110 to determine a variety of geometric properties of the dataset 135 from the transformed dataset 165 including clusters and nearest neighbors.

Depending on the implementation, the discount factor and/or the σ parameter may be published by the privacy protector 160. The discount factor and/or the σ parameter may be published along with the transformed dataset 165, for example.

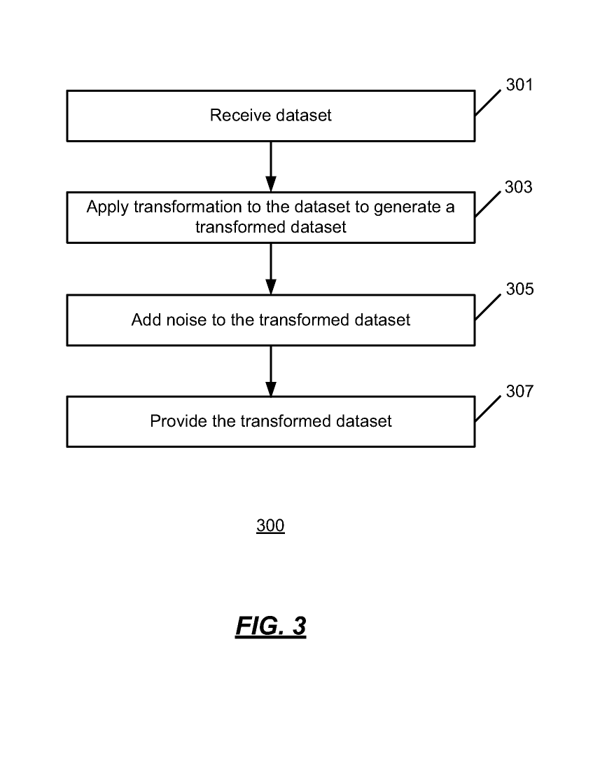

FIG. 3 is an operational flow of an implementation of a method 300 for generating a transformed dataset 165 from a dataset 135. The method 300 may be implemented by a privacy protector 160.

A dataset is received at 301. The dataset 135 may be received by the privacy protector 160 from a dataset provider 130. The dataset 135 may be a private dataset 135 and may include a plurality of rows and each row may have a plurality of values or columns. The number of values in each row of the dataset 135 corresponds to the dimension of the dataset 135. The dataset 135 may be provided to the privacy protector 160 so that the dataset 135 may be transformed in such a way to form a transformed dataset 165 that may provide privacy protection for the dataset 135, while at the same time preserving one or more geometric properties of the dataset 135.

A transformation is applied to the dataset to generate a transformed dataset at 303. The transformation may be applied by the sketch engine 210 of the privacy protector 160 to generate the transformed dataset 165. The transformation may be applied to each row of the dataset 135 and may be a function that reduces the number of dimensions of the row of the dataset 135. The transformation may be linear or non-linear, and may be published by the privacy protector 160 or may be kept secret. In some implementations, the result of the transformation applied to a row may be a sketch 215. The transformation may be a projection matrix. Other types of transformations may be used.

Noise is added to the transformed dataset at 305. The noise 225 may be added by the noise engine 220 of the privacy protector 160 to the transformed dataset 165. The noise 225 may be a noise matrix with values selected from a distribution such as the Gaussian or Laplacian distribution. Other distributions may be used. The amount of noise 225 added to the transformed dataset 165 may depend on the type of transformation that is applied by the sketch engine 210. For example, the amount of noise may be based on the Iₚ-sensitivity of the projection matrix that was used to generate the transformed dataset 165.

The transformed dataset is provided at 307. The transformed dataset 165 with the added noise 225 may be provided by the privacy protector 160 to a client device 110 associated with one or more third-party researchers. Alternatively or additionally, the transformed dataset 165 may be published so that the data 165 may be downloaded by interested third-party researchers. The transformed dataset 165 may be published along with an indicator of the type or distribution of the noise 225 that was added to the transformed dataset 165 so that the noise 225 may be accounted for when one or more geometric properties of the original dataset 135 are determined using the transformed dataset 165.

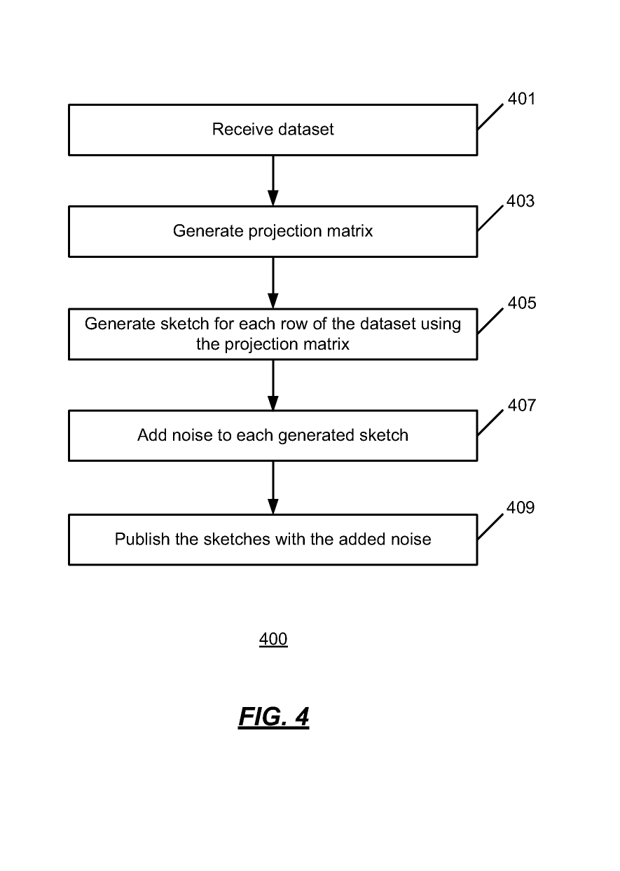

FIG. 4 is an operational flow of an implementation of a method 400 for generating a transformed dataset 165 from a dataset 135. The method 400 may be implemented by a privacy protector 160.

A dataset is received at 401. The dataset 135 may be received by the privacy protector 160 from a dataset provider 130. The dataset 135 may be a private dataset 135 and may include a plurality of rows and each row may have a plurality of values or columns. The dataset 135 may have d dimensional rows.

A projection matrix is generated at 403. The projection matrix may be generated by the sketch engine 210 of the privacy protector 160. The projection matrix may be generated based on the values of the dataset 135, or may be independent of the dataset 135. The projection matrix may map each d dimensional row of the dataset 135 to a k dimensional sketch 215, where k is much smaller than d. The entries of the projection matrix may be determined by the sketch engine 210 independently and uniformly at random from the Gaussian distribution. Other distributions or sets may be used by the sketch engine 210 to determine the values of the projection matrix.

A sketch is generated for each row of the dataset using the projection matrix at 405. Each sketch 215 may be generated by the sketch engine 210 of the privacy protector 160 by applying the projection matrix to a row of the dataset 135. Each sketch 215 may be k dimensional.

Noise is added to each generated sketch at 407. The noise 225 may be added by the noise engine 220 of the privacy protector 160 to each generated sketch 215. The noise 225 may be a noise matrix with values selected from a distribution such as the Gaussian or Laplacian distribution. Other distributions may be used. The amount of noise 225 added to each sketch 215 may depend on the Iₚ-sensitivity of the generated projection matrix.

The sketches with the added noise are published at 409. The sketches 215 with the added noise 225 may be published by the privacy protector 160 as the transformed dataset 165. The transformed dataset 165 may be published along with an indicator of the type or distribution of the noise that was added to each sketch.

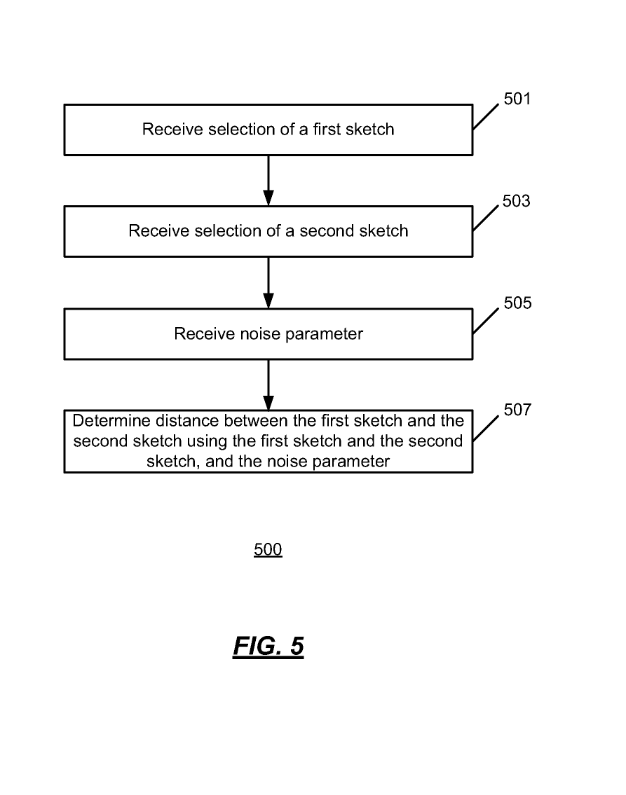

FIG. 5 is an operational flow of an implementation of a method 500 for determining a distance between two rows of the dataset 135 using the transformed dataset 165. The method 500 may be implemented by a client device 110.

A selection of a first sketch is received at 501. The selection may be made by the client device 110. The selection may be a sketch 215 from the transformed dataset 165. The first sketch 215 may correspond to a row of the dataset 135 and may be associated with a user, for example.

A selection of a second sketch is received at 503. The selection may be made by the client device 110. The selected second sketch 215 may correspond to a different row of the dataset 135 than the selected first sketch.

A noise parameter is received at 505. The noise parameter may be received by the client device 110 from the privacy protector 160. The noise parameter σ may have been published by the privacy protector 160 along with the transformed dataset 165, and may be associated with the mechanism used to generate the noise 225 that was added to each sketch 215 by the noise engine 220.

A distance between the first sketch and the second sketch is determined at 507. The distance may be determined by the client device 110 using the first sketch 215, the second sketch 215, and the noise parameter a. The client device 110 may determine the distance by accounting for the distortion added to the transformed dataset 165 by the added noise 215 using the noise parameter a. For example, the client device 110 may determine the distance between the first sketch 215 and the second sketch 215 and may subtract the discount factor 2kσ² from the determined distance where k is the dimensionality of the first and the second sketches 215. The determined distance may correspond to the actual distance between the rows of the unpublished dataset 135 corresponding to the selected first and second sketches.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a dataset by a computing device;
applying a transformation to the dataset by the computing device to generate a transformed dataset;
adding noise to the transformed dataset by the computing device; and
providing the transformed dataset with the added noise by the computing device.

2. The method of claim 1, wherein the dataset comprises a plurality of rows and the transformation is a projection matrix, and wherein applying the transformation to the dataset by the computing device to generate the transformed dataset comprises applying the projection matrix to each row of the plurality of rows.

3. The method of claim 1, wherein the applied transformation is a secret transformation, or is published.

4. The method of claim 1, further comprising selecting the applied transformation based on one or more values of the dataset, or independently of the one or more values of the dataset.

5. The method of claim 1, wherein the dataset and the transformed dataset each comprise a plurality of rows, and each row of the dataset has a dimension that is greater than a dimension of each row of the transformed dataset.

6. A method comprising:
receiving a dataset by a computing device, wherein the dataset comprises a plurality of rows and each row has a first number of dimensions;
for each row of the dataset, generating a sketch from the row by the computing device, wherein the sketch has a second number of dimensions that is less than the first number of dimensions;
for each sketch, adding noise to the sketch by the computing device; and
providing the generated sketches with the added noise by the computing device.

7. The method of claim 6, wherein the generated sketch is a linear sketch or a non-linear sketch.

8. The method of claim 6, further comprising generating a projection matrix that maps rows in the first number of dimensions to sketches in the second number of dimensions, and wherein generating a sketch from a row comprises applying the projection matrix to the row.

9. The method of claim 8, wherein the projection matrix has an associated Iₚ-sensitivity, and further comprising determining the noise to add to each sketch based on the associated Iₚ-sensitivity.

10. The method of claim 6, further comprising generating the added noise based on a privacy guarantee.

11. The method of claim 10, wherein the privacy guarantee comprises one or more of ε-differential privacy, (ε,δ)-differential privacy, anonymity, or a comparison of a posterior probability to a prior probability.

12. The method of claim 6, wherein providing the generated sketches with the added noise comprises publishing the generated sketches with the added noise.

13. The method of claim 6, further comprising:
receiving a selection of a first sketch of the generated sketches with the added noise;
receiving a selection of a second sketch of the generated sketches with the added noise;
receiving a noise parameter associated with the added noise; and
determining a geometric property of the first sketch and the second sketch using the first sketch, the second sketch, and the noise parameter.

14. The method of claim 13, wherein the geometric property is one or more of distances, clusters, or nearest neighbors.

15. The method of claim 6, further comprising receiving a privacy guarantee, and further comprising selecting the second number of dimensions and the added noise based on the privacy guarantee.

16. The method of claim 15, wherein the second number of dimensions and the added noise are selected to provide the privacy guarantee, and to minimize distortions of one or more geometric properties of the dataset.

17. A system comprising:
a dataset provider that generates a dataset, wherein the dataset comprises a plurality of rows and each row has a first number of dimensions; and
a privacy protector that:
receives the generated dataset; and
for each row of the generated dataset,
generates a sketch from the row, wherein the sketch has a second number of dimensions that is less than the first number of dimensions; and
publishes the generated sketches.

18. The system of claim 17, wherein the privacy protector further adds noise to each generated sketch and publishes the generated sketches with the added noise.

19. The system of claim 17, wherein the privacy protector further generates a projection matrix that maps rows in the first number of dimensions to sketches in the second number of dimensions, and the privacy protector generates a sketch from a row by applying the projection matrix to the row.

20. The system of claim 17, further comprising:
a computing device adapted to:
receive the generated sketches;
receive a selection of a first sketch of the generated sketches;
receive a selection of a second sketch of the generated sketches; and
determine a geometric property of the row used to generate the first sketch and the row used to generate the second sketch using the first sketch and the second sketch.
